(19) United States
(12) Patent Application Publication
(10) Pub. No.: US 2007/0056169 A1
(43) Pub. Date: Mar. 15, 2007

(54) Folding knife with integral handle

(75) Inventor: Yang-Fu Cheng, Taipei (TW)

Correspondence Address: BACON & THOMAS, PLLC, 625 SLATERS LANE, FOURTH FLOOR, ALEXANDRIA, VA, 22314, US

(73) Assignee: KANTAS PRODUCTS CO., LTD., Taipei (TW)

(21) Appl. No.: 11/224,230

(22) Filed: Sep. 13, 2005

(51) Int. Cl. B26B 3/06

(52) U.S. Cl. 30/153

(57) ABSTRACT

The present invention is to provide a folding knife comprising a blade and an integrally formed handle, the handle including a groove and having its forward end pivotably connected to a rear end of the blade such that the blade is adapted to lie within the groove by pivoting in its closed position, the handle further including an integral extension below the groove such that the rear end of the blade is stopped by the extension when the blade pivots into an open position by pivoting about a forward end of the groove for preventing the blade from further pivoting into the groove.

### FIELD OF THE INVENTION

The present invention relates to folding knives and more particularly to such a folding knife having an integral handle with improved characteristics.

### BACKGROUND OF THE INVENTION

Science and technology have known a rapid, spectacular development as time involves in which not only high technology products but also consumer products have made a rapid progress. Thus, people can enjoy convenience of the continuing improvements of such consumer products. The motive for the improvements is that people always complain about life inconvenience due to poor design of many consumer products. As an end, life quality is improved due to the improvements.

Knives are important tools in our daily life. Also, many types of knife on the market are available. A conventional folding knife of them is shown in FIG. 1 and comprises a blade 100 and a handle 200 including first, second, and third boards 201, 202, and 203. Both the first and third boards 201 and 203 are made of aluminum materials and are formed by pressing. The second board 202 is formed by punching. The first board 201 comprises a first through hole 280, a plurality of first apertures 210, and a staged projection 230. The second board 202 also comprises a second through hole 280, an extension 221, and an elongate riser 231. A plurality of second apertures 210 are provided on both the second board 202 and the riser 231. The third board 203 comprises a third through hole 280 and a plurality of third apertures 210. Align the first, second, and third apertures 210 of the first, second, and third boards 201, 202, and 203. Next, align the first, second, and third through holes 280 of the first, second, and third boards 201, 202, and 203. A rear portion (i.e., heel) of the blade 100 is disposed between the second and third boards 202 and 203 with a through hole at the heel aligned with the second and third through holes 280. Next, drive a plurality of fasteners 300 through the aligned projections 210 to initially fasten the first, second, and third boards 201, 202, and 203 together. Finally, insert a pin 310 having inner threads through the third through hole 280, the through hole of the blade 100, and the second and first through holes 280 to threadedly secure to a bolt 310 for completing the assembly of the folding knife in which the blade 100 is pivotal about the pin 310. In view of above, it is understood that for manufacturers of the art a number of manufacturing and assembly steps are required to assemble the blade 100 with other components of the folding knife. This is a tedious and time consuming process with many components involved. Thus, the manufacturers of the art are greatly bothered by the poor design of the handle 200. Moreover, many complicated components of the folding knife may inevitably bother the manufacturers of the art since they have to prepare many spare parts, resulting in an increase in the manufacturing cost including labor and material. Thus, it is desirable among the manufacturers of the art to provide an improved folding knife with an integral handle having the advantages of saving time and labor in both the manufacturing and assembly steps with the elimination of fasteners and the assembly of same.

### SUMMARY OF THE INVENTION

After considerable research and experimentation, a folding knife having an integral handle according to the present invention has been devised so as to overcome the above drawbacks of the prior art.

It is an object of the present invention to provide a folding knife comprising a blade and an integrally formed handle, the handle including a groove and having its forward end pivotably connected to a rear end of the blade such that the blade is adapted to lie within the groove by pivoting in its closed position, the handle further including an integral extension below the groove such that the rear end of the blade is stopped by the extension when the blade pivots into an open position by pivoting about a forward end of the groove for preventing the blade from further pivoting into the groove. Alternatively, the forward end of the handle is adapted to urge against the back of the blade for preventing the blade from further pivoting out of the groove. By configuring as above, the folding knife of the present invention can stably fix the blade completely pivoted out of the groove. It not only greatly saves the manufacturing cost including material, components and its assembly, but also simplifies and facilitates the assembly, and shortens the assembly time since the handle is integrally formed with the extension.

It is another object of the present invention, there are provided a plurality of openings formed on the plate of the handle. The provision of the openings with such arrangement and shape adds an aesthetic effect to the folding knife and causes the folding knife to be more attractive. Moreover, the provision of the openings on the handle can remove a portion of the plate, resulting in sort of a reduction of the weight of the folding knife.

In another aspect of the present invention, there are provided at least one fourth hole formed on an end of the handle, and a hook member having outer threads adapted to secure to the handle by threadedly securing to the fourth hole.

The above and other objects, features and advantages of the present invention will become apparent from the following detailed description taken with the accompanying drawings.

### BRIEF DESCRIPTION OF THE DRAWINGS

FIG. 1 is an exploded view of a conventional folding knife;

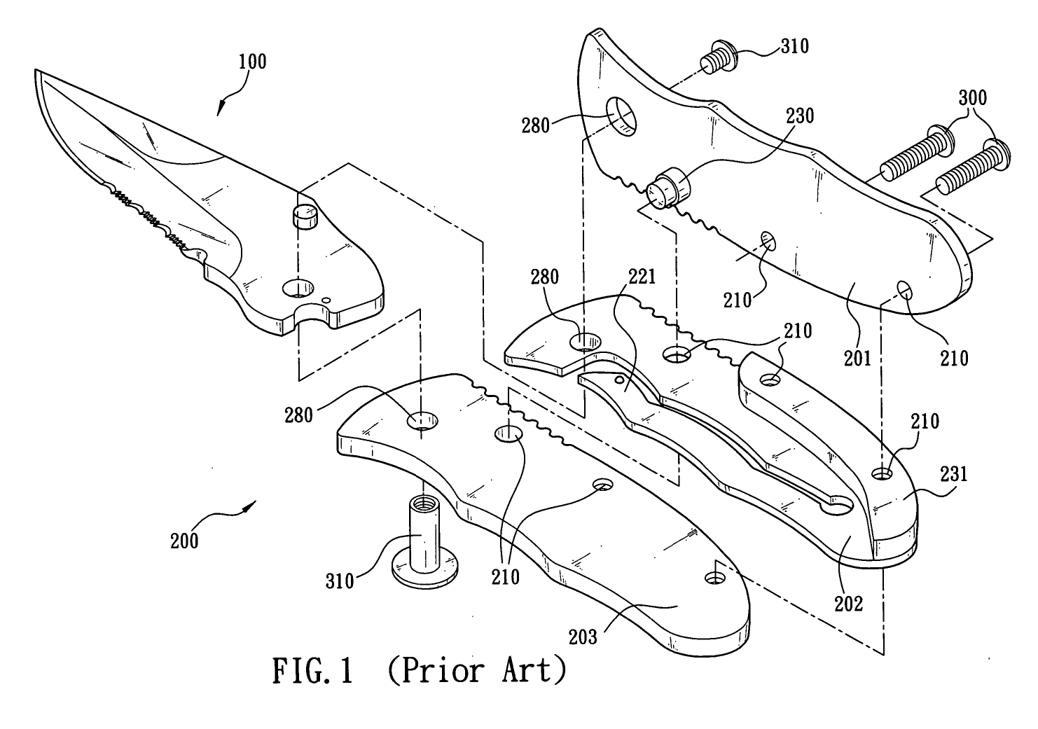

FIG. 2 is an exploded view of a folding knife incorporating an integral handle according to a first preferred embodiment of the invention;

FIG. 3 is a bottom plan view of the extended handle in FIG. 2;

FIG. 4 is a side view of the handle in an embodiment of the invention;

FIG. 5 is a top plan view of an integral handle according to a second preferred embodiment of the invention to be assembled with a blade of a folding knife; and

FIG. 6 is an exploded view of a folding knife incorporating the handle in FIG. and other associated components.

### DETAILED DESCRIPTION OF THE PREFERRED EMBODIMENTS

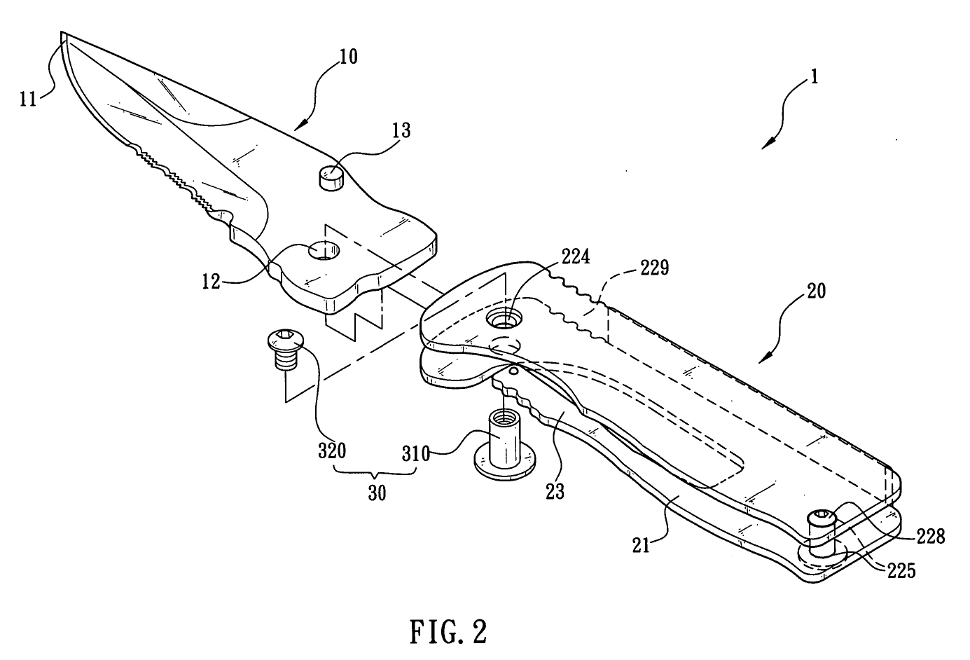

Referring to FIG. 2, a folding knife with an integral handle in accordance with a first preferred embodiment of the invention comprises a blade 10 and a handle 20. Each component is discussed in detailed below. The handle 20 is formed integrally. The handle 20 comprises a groove 21. The blade 10 comprises a point 11 at a forward end and a heel at a rear end to be pivotably assembled with a forward end of the handle 20. The blade 10 is adapted to lie within the groove 21 by pivoting in its closed position. The handle 20 further comprises an integral extension 23 projecting toward a pivot joining portion of the handle 20 and the blade 10. The extension 23 is slightly flexibly bent toward an opposite side of the groove 21. As such, the heel of the blade 10 may be stopped by the extension 23 when the blade 10 pivots into an open position by pivoting about a forward end the groove 21. As a result, the blade 10 is prevented from further pivoting into the groove 21. Also, the forward end of the handle 20 proximate the pivot joining portion is adapted to urge against the back of the blade 10. As a result, the blade 10 is prevented from further pivoting out of the groove 21. To the contrary, for receiving the blade 10 in the groove 21, a user may bend the extension 23 to disengage the blade 10 with the extension 23. Thereafter, the blade 10 is adapted to lie within the groove 21 by pivoting in its closed position. By configuring as above, the folding knife 1 of the invention can stably fix the blade 10 completely pivoted out of the groove 21. It not only greatly saves the manufacturing cost including material, components and its assembly, but also simplifies and facilitates the assembly, and shortens the assembly time since the handle 20 is integrally formed with the extension 23.

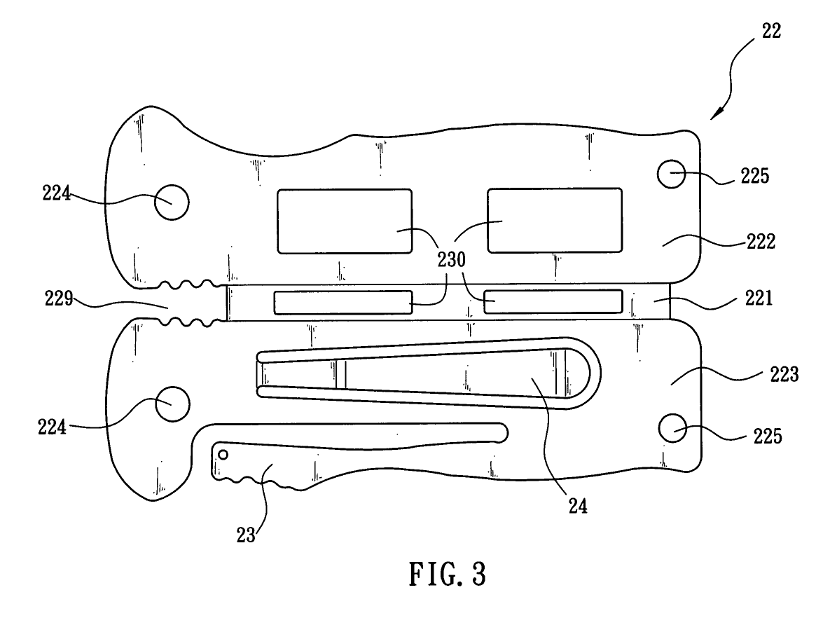

Referring to FIGS. 2 and 3, in the invention the handle 20 comprises a plate 22 formed integrally by, for example punching. The plate 22 comprises first, second, and third sections 221, 222, and 223. The second and third sections 222 and 223 are provided at two opposite sides of the first section 221. The first section 221 has an area smaller than that of each of the second and third sections 222 and 223. One of the second and third sections 222 and 223 bends toward the other about the first section 221 and thus each of the second and third sections 222 and 223 is disposed at an angle about the first section 221. The bent plate 22 thus forms the handle 20 of U-section. A space defined by the second and third sections 222 and 223 is formed as the groove 21 for receiving the blade 10.

The handle 20 of the folding knife 1 is formed integrally by the plate 22. However, the integral handle 20 may have an adverse effect to the dexterity of using the folding knife 1 due to overweight. Thus, referring to FIG. 3 again, in the first preferred embodiment of the invention a plurality of openings 230 are formed on the plate 22. The provision of the openings 230 with such arrangement and shape adds an aesthetic effect to the folding knife 1 and causes the folding knife 1 to be more attractive. Moreover, the provision of the openings 230 on the handle 20 may remove a portion of the plate 22, resulting in a great reduction of the weight of the folding knife 1.

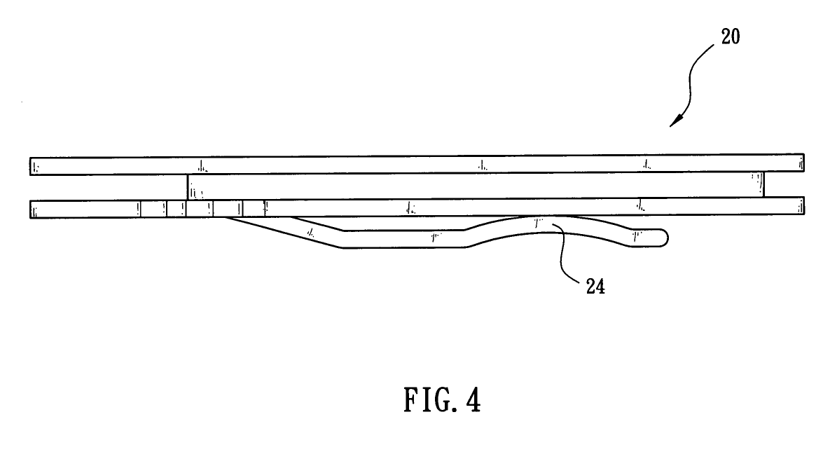

Referring to FIGS. 3 and 4, a flexible clip 24 is integrally formed on the second section 222 or the third section 223 of the handle 20. One end of the clip 24 is formed at the handle 20 and the other end thereof is slightly bent outward from the folding knife 1. A portion of the clip 24 proximate its one end at the handle 20 is protruded out of the groove 21 and the other end of the clip 24 is extended toward the groove 21 to be proximate the handle 20 (see FIG. 2). As such, an elongate gap is formed above the clip 24 (i.e., a gap formed between the clip 24 and the handle 20). As a result, the folding knife 1 is adapted to fix to an object by clipping.

Referring to FIGS. 2 and 3 again, in the first preferred embodiment of the invention the plate 22 is substantially shaped as a rectangle. An elongate side of each of the second and third sections 222 and 223 is formed with either side of the first section 221. Two opposite first through holes 224 are formed on the plate 22. That is, one first through hole 224 is formed on the second section 222 and the other aligned first through hole 224 is formed on the third section 223. A hole 12 is formed on the heel of the blade 10 to be aligned with the first through holes 224. A pivot member 30 is formed between the first through holes 224 and through the hole 12. The pivot member 30 comprises a pin 310 having inner threads, and a bolt 320. The pin 310 is adapted to insert into one first through hole 224 and the hole 12 from a top surface of the handle 20, and the bolt 320 is adapted to insert into the other first through hole 224 and the hole 12 from a bottom surface of the handle 20 to threadedly secure to the pin 310 for completing the assembly of the blade 10 and the handle 20.

Referring to FIGS. 2 and 3 again, in the first preferred embodiment the plate 22 further comprises a cavity 229 at a forward end of the first section 221. The extension 23 is formed at one side of either one of the second and third sections 222 and 223. After assembling the handle 20 with the blade 10, the blade 10 is adapted to pivot out of the groove 21. The heel of the blade 10 proximate the pivot member 30 is thus free from being stopped by the handle 20 with the provision of the cavity 229. That is, the blade 10 may pass the cavity 229 such that the blade 10 may complete its pivoting operation of extending out of the groove 21. Advantageously, a further pivoting of the blade 10 out of the groove 21 may be stopped as it contacts a closed end of the cavity 229 of the handle 20.

Moreover, the prior folding knife comprises at least two boards. Also, at least three fasteners are required to fasten the handle in order to fix a receiving space thereof as implemented by the prior folding knife. Referring to FIGS. 2 and 3 again, in the first preferred embodiment the handle 20 comprises at least two opposite second through holes 225 at a rear end distal the pivot member 30. The second through holes 225 are formed on the second and third sections 222 and 223 respectively and are disposed correspondingly to the first through holes 224 at the front end of the handle 20. A bolt 228 is inserted into the second through holes 225. Thus, two opposite portions of the handle 20 are spaced apart and are supported by the pivot member 30 and the bolt 228 when the handle 20 is formed integrally. As such, the handle 20 is not subject to deformation when an excessive force is exerted thereon. As contemplated by the invention, the provision of the pivot member 30 and the bolt 228 can reliably fix a receiving space of the handle 20.

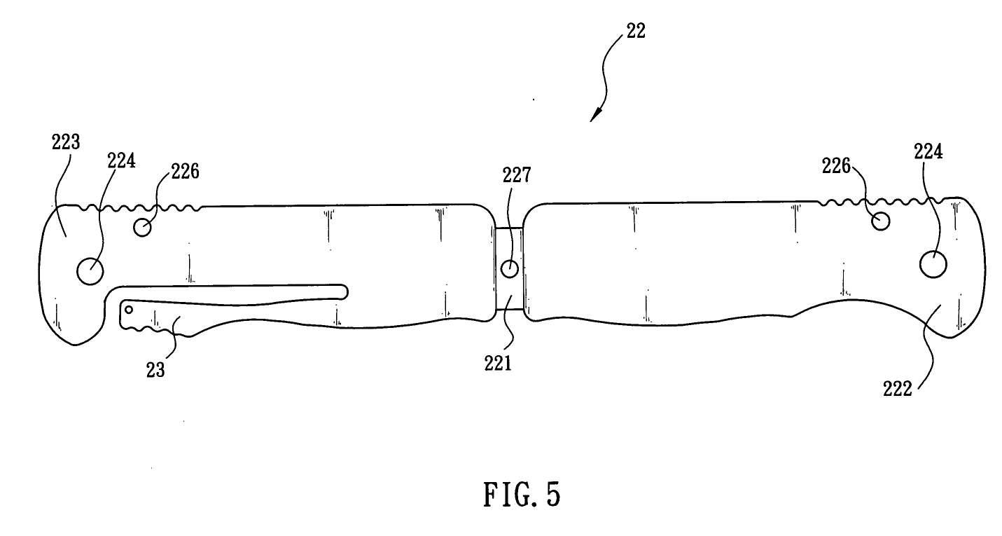

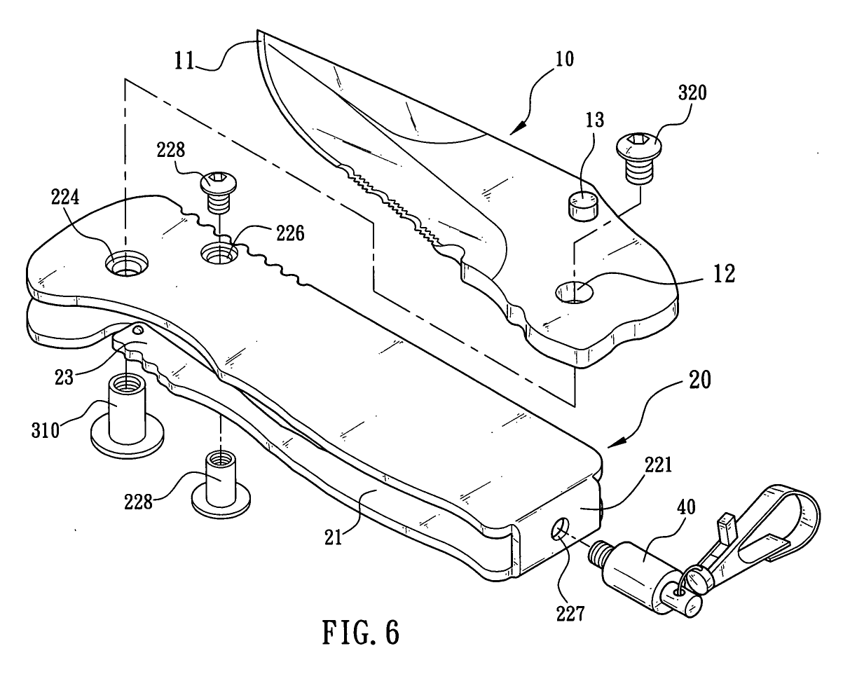

Referring to FIGS. 5 and 6, a second preferred embodiment of the invention is shown. The plate 22 is an elongate one. Rear ends of the second and third sections 222 and 223 are formed with both ends of the first section 221 respectively. The plate 22 comprises two opposite first through holes 224 on both surfaces. The first through holes 224 are formed at a forward end of the plate 22 in an aligned relationship. The first through holes 224 are formed on forward ends of the second and third sections 222 and 223 respectively and are disposed distal the rear first section 221. A hole 12 is formed on the heel of the blade 10 to be aligned with the first through holes 224. A pivot member 30 is formed between the first through holes 224 and through the hole 12 (see FIG. 2). The pivot member 30 comprises a pin 310 having inner threads, and a bolt 320. The pin 310 is adapted to insert into one first through hole 224 and the hole 12 from a top surface of the handle 20, and the bolt 320 is adapted to insert into the other first through hole 224 and the hole 12 from a bottom surface of the handle 20 to threadedly secure to the pin 310 for pivotably assembling the blade 10 and the handle 20.

In addition, at least one third through hole 226 is formed on the second section 222 in an aligned relationship to at least one third through hole 226 formed on the third section 223. The third through hole 226 is disposed proximate an edge of each of the second and third sections 222 and 223 and is distal an opening of the groove 21. The handle 20 is formed by the integral plate 22. A fastener (e.g., pin and bolt combination) 228 is inserted into the aligned third through holes 226 of the handle 20 for enhancing a structural strength of the handle 20 and forming a receiving space in the handle 20. The fastener 228 proximate the first through holes 224 is adapted to stop the blade 10 as the blade 10 pivots out of the groove 21. As an end, a further pivoting of the blade 10 out of the groove 21 is prohibited.

Referring to FIGS. 5 and 6 again, in the second preferred embodiment at least one fourth hole 227 is formed on the first section 221. A member (e.g., hook) 40 may secure to the handle 20 by threadedly securing to the fourth hole 227.

In both preferred embodiments, the blade 10 further comprises a projection 13 on its one surface proximate the hole 12. The projection 13 is adapted to stop an edge of either one of the second and third sections 222 and 223 when the blade 10 pivots to lie within the groove 21. As such, the blade 10 is prevented from pivoting further into the groove 21. This can prevent the blade 10 from being damaged due to strong collision.

While the invention herein disclosed has been described by means of specific embodiments, numerous modifications and variations could be made thereto by those skilled in the art without departing from the scope and spirit of the invention set forth in the claims.

What is claimed is:

1. A folding knife comprising:
a blade including a point at a forward end; and
an integral handle having a forward end pivotably connected to a rear end of the blade, the handle including a groove and an integral extension below the groove, the extension being slightly flexibly bent toward an opposite side of the groove such that the rear end of the blade is stopped by the extension when the blade pivots into an open position by pivoting about a forward end of the groove.

2. The folding knife of claim 1, wherein the handle is of U-section and is formed of a plate, the plate including first, second, and third sections, the second and the third sections being provided at two opposite sides of the first section, the first section having an area smaller than that of each of the second and the third sections, one of the second and the third sections bent toward the other about the first section, and each of the second and the third sections being disposed at an angle about the first section so as to form a space defined by the second and the third sections as the groove for receiving the blade.

3. The folding knife of claim 2, wherein the plate further comprises a plurality of aesthetic openings for decreasing weight of the folding knife.

4. The folding knife of claim 2, wherein the extension is formed at one side of either one of the second and the third sections.

5. The folding knife of claim 2, further comprising a flexible clip integrally formed on the second section or the third section of the handle, the clip being adapted to fix to an object, and wherein one end of the clip is formed at the handle and the other end thereof is slightly bent outward from the folding knife.

6. The folding knife of claim 5, wherein a portion of the clip proximate its one end at the handle is protruded out of the groove and the other end of the clip is extended toward the groove to be proximate the handle so as to form an elongate gap between the clip and the handle.

7. The folding knife of claim 2, wherein the plate is substantially rectangular, and wherein an elongate side of each of the second and the third sections is formed with either side of the first section.

8. The folding knife of claim 7, wherein the plate further comprises two opposite first through holes, one first through hole being formed on the second section and the other aligned first through hole being formed on the third section, the folding knife further comprising a hole formed on the rear end of the blade aligned with the first through holes, and a pivot member formed between the first through holes and being through the hole.

9. The folding knife of claim 8, wherein the pivot member includes a pin having inner threads, and a bolt, the pin being adapted to insert into one first through hole and the hole from a top surface of the handle, and the bolt being adapted to insert into the other first through hole and the hole from a bottom surface of the handle to threadedly secure to the pin for pivotably assembling the blade and the handle.

10. The folding knife of claim 7, wherein the plate further comprises a cavity formed at a forward end of the first section, and wherein a pivoting of the blade about the groove into an open position is stopped when the blade contacts a closed end of the cavity.

11. The folding knife of claim 8, wherein the handle further comprises at least two opposite second through holes at a rear end distal the pivot member, the second through holes being formed on the second and the third sections respectively and being disposed correspondingly to the first through holes at a forward end of the handle, the folding knife further comprising a bolt inserted into the second through holes and disposed therebetween.

12. The folding knife of claim 2, wherein the plate is elongate, and wherein rear ends of the second and the third sections are formed with both ends of the first section respectively.

13. The folding knife of claim 12, wherein the plate further comprises two opposite first through holes on both surfaces, the first through holes being disposed at a forward end of the plate in an aligned relationship, the first through holes being disposed at forward ends of the second and the third sections respectively and being disposed distal the rear first section, the folding knife further comprising a hole formed on the rear end of the blade aligned with the first through holes, and a pivot member formed between the first through holes and being through the hole.

14. The folding knife of claim 13, wherein the pivot member comprises a pin having inner threads, and a bolt, the pin being adapted to insert into one first through hole and the hole from a top surface of the handle, and the bolt being adapted to insert into the other first through hole and the hole from a bottom surface of the handle to threadedly secure to the pin for pivotably assembling the blade and the handle.

15. The folding knife of claim 12, further comprising at least one third through hole formed on each of the second and the third sections in an aligned relationship therebetween, and a fastener inserted into the aligned third through holes and disposed therebetween for maintaining the space in the handle.

16. The folding knife of claim 15, wherein the fastener proximate the first through holes is adapted to stop the blade as the blade pivots out of the groove.

17. The folding knife of claim 12, further comprising at least one fourth hole formed on the first section, and a hook member having outer threads adapted to secure to the handle by threadedly securing to the fourth hole.

18. The folding knife of claim 7, wherein the blade further comprises a projection formed on its one surface proximate the hole of the blade, the projection being adapted to stop an edge of either one of the second and third sections when the blade pivots to lie within the groove such that the blade is prevented from pivoting further into the groove.

19. The folding knife of claim 13, wherein the blade further comprises a projection formed on its one surface proximate the hole of the blade, the projection being adapted to stop an edge of either one of the second and third sections when the blade pivots to lie within the groove such that the blade is prevented from pivoting further into the groove.
